(19) United States
(12) Patent Application Publication
(10) Pub. No.: US 2006/0087920 A1
(43) Pub. Date: Apr. 27, 2006

(54) Timer having audio-visual reminding device

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/968,938

(22) Filed: Oct. 21, 2004

(51) Int. Cl. G04F 8/00; G04F 10/00

(52) U.S. Cl. 368/109

(57) ABSTRACT

A timer having an audio-visual reminding device is disclosed. The timer comprises a timer body on which a plurality of function buttons, a speaker, a monitor, a microphone, a slot for a storage device, and input/output device are mounted, wherein the timer is used to appoint an important time and perform a pre-recordation of an important affair by the microphone, and an image is pre-stored in the storage device so as to show the prerecorded sound and image via the speaker and the monitor at the important time for reminding user of the timing of dealing with this important affair.

### BACKGROUND OF THE INVENTION

The present invention relates to a timer having an audio-visual reminding device, which is suitable for a clock, a watch, or an apparatus having a structure similar to the timer.

Since modern people always take two or more jobs at the same time, a traditional calendar or a personal digital assistant (PDA) is commonly utilized to note them down so as to remind user lest he forgets to deal with them. The reminding way of the traditional calendar merely roughly notifies the user that there is something needed to be dealt in someday unless he makes a detailed note himself and specifies exact hour and minute that these affairs should be done. However, it is necessary for the user to check this detailed note himself. If the user is too busy to check this calendar, these affairs will not be processed.

Although PDA can specify a specific time which is subdivided into day, hour, and minute, and make a reminding sound. However, this reminding sound is merely a monotonous sound. When the user hears the monotonous sound, he must check this PDA to browse through the indicated affairs. If this PDA is put on the desk or in the business package and the user does not take his seat, then he will not be reminded of the reminding sound of the PDA. In this condition, this user will miss the timing of implementing these affairs.

The present invention has been made in view of the above circumstances and provides a timer having an audio-visual reminding device. The present inventor has been made diligent studies with a quiet mind to design and fabricate a timer by which the user will not miss the implementing timing. The timer having the audio-visual reminding device is provided for the consumer in accordance with motivations of the present invention.

### SUMMARY OF THE INVENTION

The primary purpose of the present invention is to provide a timer having an audio-visual reminding device that exactly reminds user of the timing of dealing with affairs that need to be executed such that it is not necessary for the user to check his calendar himself.

Another purpose of the present invention is to provide a timer having an audio-visual reminding device that enables user to record the reminding voice or content, which are related to affairs that need to be dealt.

According to the aforementioned purposes of the present invention, a timer having an audio-visual reminding device is disclosed. The timer comprises a timer body on which a plurality of function buttons, a speaker, a monitor, a microphone, a slot for a storage device, and input/output device are mounted, wherein the timer is used to appoint an important time and perform a pre-recordation of an important affair by the microphone, and an image is pre-stored in the storage device so as to show the prerecorded sound and image via the speaker and the monitor at the important time for reminding user of the timing of dealing with this important affair.

The other features and preferred embodiments of the present invention will now be described with reference to the accompanying drawings.

### BRIEF DESCRIPTION OF THE DRAWINGS

FIG. 1 is a schematic view showing outward appearance of a preferred embodiment of the present invention.

FIG. 2 is a block diagram showing the circuitry of the preferred embodiment of the present invention.

FIG. 3A is a schematic view showing one usage of a medium size carrier bag body that has multiple partitions.

FIG. 3B is a schematic view showing another usage of a medium size carrier bag body that has multiple partitions.

### DETAILED DESCRIPTION OF THE PREFERRED EMBODIMENT

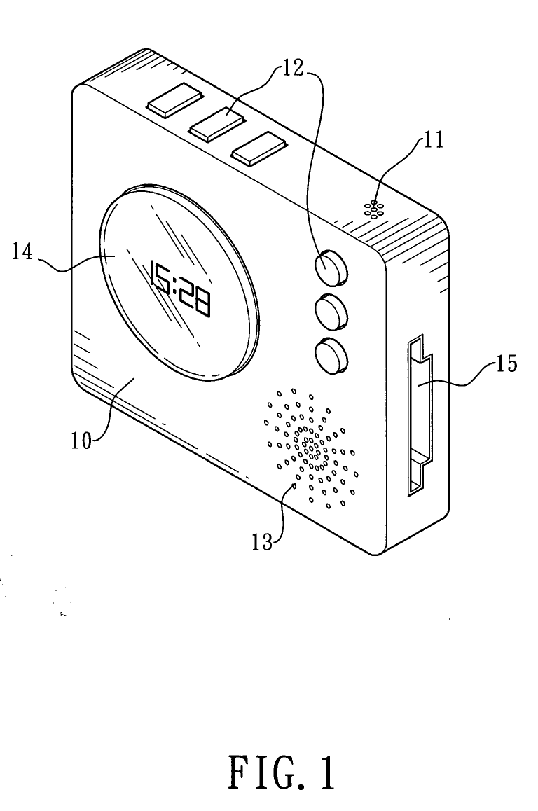

Referring to FIG. 1, a timer having an audio-visual reminding device of the present invention comprises a timer body 10 on which a LCD monitor 14, a microphone 11, a plurality of function buttons 12, a speaker 13, and a slot 15 for a storage device are mounted.

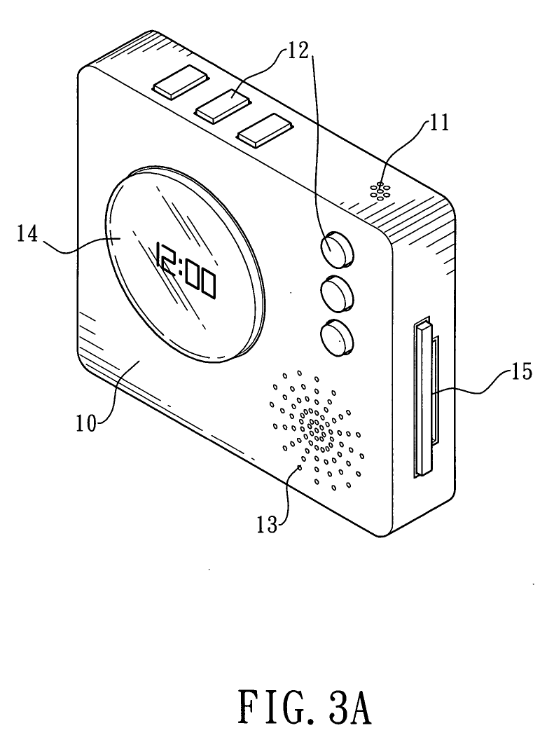

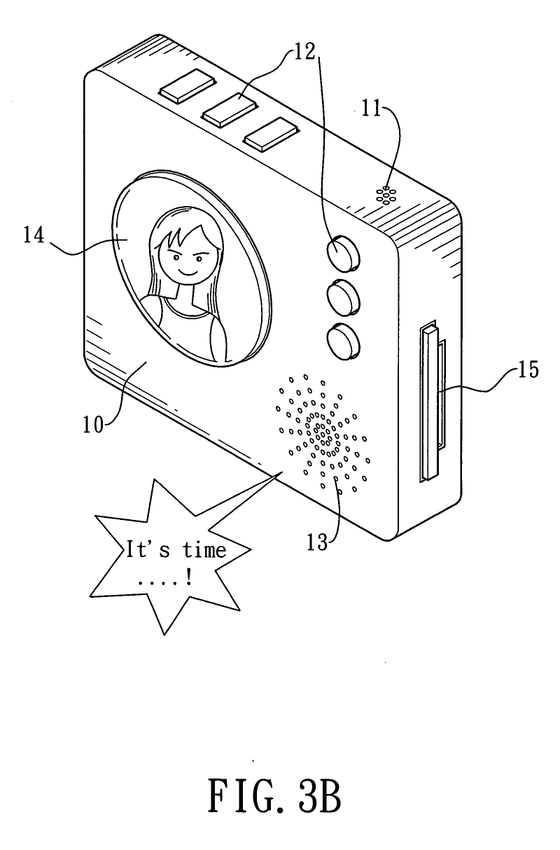

The timer body 10 provides with the function of counting time and shows time on the monitor 14. In addition, the function buttons 12 mounted on the timer body 10 can be used to appoint a reminding time. The message of affair that needs to be dealt with at this appointed time can be prerecorded so as to show the prerecorded message via the speaker 13. As a result, the user can hear the recorded message through the timer body 10 even if he is not taken his seat, as shown in FIG. 3. Besides, other person who has heard the reminding message can contact with the concerned person by means of telephone such that the user is able to deal with the affair even if he is not taken his seat.

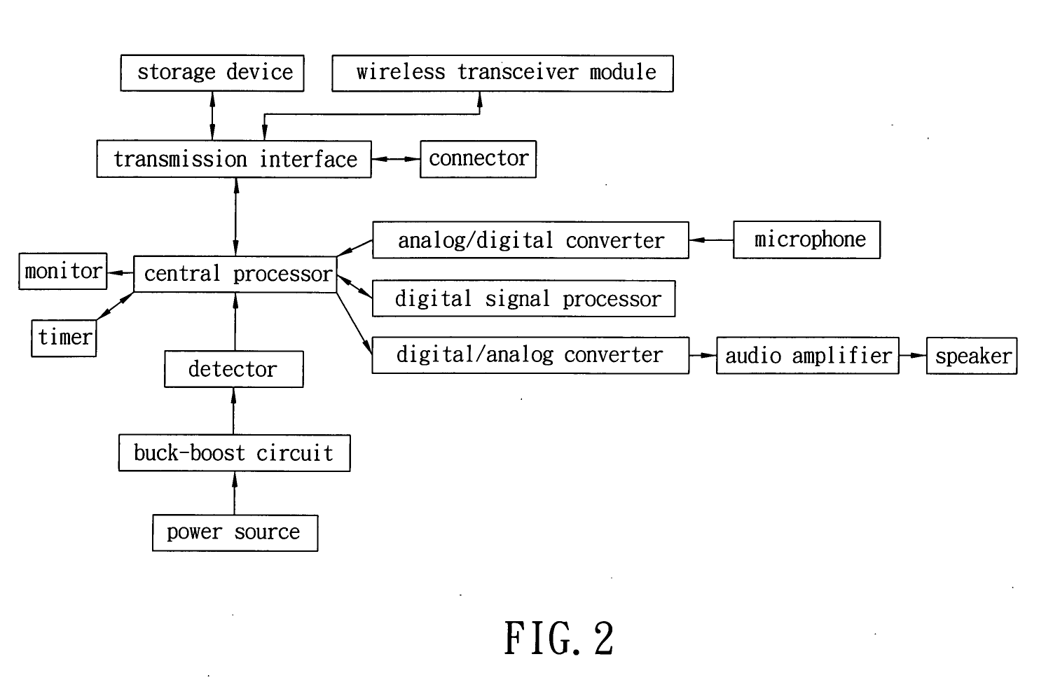

Referring to FIG. 2, the interior circuit of the timer body 10 disclosed in the timer body 10 primarily comprises a central processing unit (CPU) that connects with a timer circuit and the monitor 14. The timer circuit is further connected to the monitor 14. The microphone 11 is connected to the CPU through an analog to digital converter. The CPU stores the audio signal into a memory card inserted in the slot 15 through a transmission interface, which is further connected to an input/output device, for example, a wireless transceiver or a USB connector. The CPU is connected to the speaker 13 through the digital to analog converter and an audio amplifier. The timer body 10 can connect to a computer through the USB connector so as to store the digital image data into the memory card, which is inserted into the slot 15. By using the function buttons 12 to perform the setting, when an appointed time is reached, the speaker 13 will show the prerecorded voice and the image data will be displayed instead of showing time on the monitor 14. As a result, the reminding device provides more humanity and becomes more lively and vividly.

Moreover, when the present invention is applied to families, voice messages for reminding important days, for example, family member's birthday, wedding anniversary, common entrance examination day and so forth can be prerecorded by using the function buttons 12 of the timer body 10. In addition, through a digital camera, images of family members such as mother can be recorded. In the other hand, images, which are captured from the computer, can be stored in the memory card that inserts into the slot 15. In normal condition, the monitor 14 of the timer body 10 shows date and hour, and the sound of talking hours, which is displayed by the memory card inserted in the slot 15, can be set to traditional ringing, ticktack, bird's sound, music sound, and so forth by using function buttons 12. When the appointed time and date is reached, the speaker 13 displays the prerecorded reminding voice and the monitor 14 shows the stored films or pictures so as to promote life amenity. As a result, the timer body 10 becomes a work and rest center.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purpose by providing user with a timer having an audio-visual reminding device to directly remind user of affairs that need to be dealt with through voice and image. Therefore, it is not possible for the user to miss the timing to handle these affairs because of too busy to check his calendar. The application that complies with utility is therefore submitted for a patent.

What the invention claimed is:

1. A timer having an audio-visual reminding device, comprising a timer body on which a plurality of function buttons, a speaker, a monitor, a microphone, a slot for a storage device, and input/output device are mounted, wherein the timer is used to appoint an important time and perform a pre-recordation of an important affair by the microphone, and an image is pre-stored in the storage device so as to show the prerecorded sound and image via the speaker and the monitor at the important time for reminding user of the timing of dealing with the important affair.

2. The timer having an audio-visual reminding device of claim 1, wherein the input/output device on the timer body further comprises: a USB connector and a wireless transceiver.

3. The timer having an audio-visual reminding device of claim 1, wherein the storage device is a memory card.

4. The timer having an audio-visual reminding device of claim 1, wherein the storage device is a removable hard disk.
